(19) United States
(12) Patent Application Publication
(10) Pub. No.: US 2018/0144349 A1
(43) Pub. Date: May 24, 2018

(54) SYSTEMS AND METHODS FOR DETERMINING LOCAL-LEVEL DEMOGRAPHIC DISTRIBUTION OF SUBSCRIBERS OF SERVICE PROVIDERS

(71) Applicant: Facebook, Inc., Menlo Park, CA (US)

(72) Inventors: Aude Hofleitner, San Francisco, CA (US); Bogdan State, Menlo Park, CA (US); Vincent Gonguet, Menlo Park, CA (US); Andreas Gros, Menlo Park, CA (US); Timothee Charles Carnus, Corneslcourt (IE)

(21) Appl. No.: 15/359,493

(22) Filed: Nov. 22, 2016

(51) Int. Cl. G06Q 30/02; H04L 29/08; H04L 12/24

(52) U.S. Cl. CPC G06Q 30/0201; G06Q 50/01; H04L 41/142; H04L 67/18

(57) ABSTRACT

Systems, methods, and non-transitory computer readable media can determine a geographical region associated with a service provider. An average value of a metric for subscribers of the service provider in the geographical region can be determined, where the subscribers include users of a system. A demographic subset of the subscribers can be determined based on one or more attributes associated with the subscribers. A skew score for the demographic subset can be determined, where the skew score is indicative of a variation of the demographic subset from the average value of the metric.

### FIELD OF THE INVENTION

The present technology relates to the field of social networks. More particularly, the present technology relates to techniques for determining distribution information relating to subscribers of service providers, such as telecommunication operators.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Service providers can provide services in various geographical regions. As an example, one or more telecommunication operators can provide communication services in certain geographical regions. People in a geographical region can subscribe to communication services of one or more telecommunication operators available in the geographical region. Subscribers of one or more telecommunication operators in a geographical region can include users of a social networking system in the geographical region.

### SUMMARY

Various embodiments of the present disclosure can include systems, methods, and non-transitory computer readable media configured to determine a geographical region associated with a service provider. An average value of a metric for subscribers of the service provider in the geographical region can be determined, where the subscribers include users of a system. A demographic subset of the subscribers can be determined based on one or more attributes associated with the subscribers. A skew score for the demographic subset can be determined, where the skew score is indicative of a variation of the demographic subset from the average value of the metric.

In some embodiments, the geographical region is a portion of a city, the system is a social networking system, and the service provider is a telecommunication operator.

In certain embodiments, the one or more attributes are selected from one or more attributes associated with the users of the system.

In an embodiment, the one or more attributes include one or more of: an age, an age range, a gender, a household size, a device brand, a device manufacturer, a device model, a device tenure, or network usage.

In some embodiments, the determining the skew score for the demographic subset is based on a bootstrapping statistical technique.

In certain embodiments, a distribution of values of the metric for the demographic group can be determined based on the bootstrapping statistical technique.

In an embodiment, a bootstrapping sample is selected from subscribers of one or more service providers in the region that have the one or more attributes associated with the demographic group.

In some embodiments, the skew score is determined as: a p-value of the distribution of the values of the metric for the demographic group divided by the average value of the metric.

In certain embodiments, the average value of the metric is determined relative to subscribers of one or more service providers in the geographical region.

In an embodiment, the metric includes one or more of: a market share, a share of gross adds, or a share of churn.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example local distribution determination module configured to determine a demographic distribution of subscribers of a service provider in a geographical region, according to an embodiment of the present disclosure.

FIG. 2 illustrates an example skew score generation module configured to generate skew scores associated with a demographic group in a geographical region, according to an embodiment of the present disclosure.

FIG. 3A illustrates an example chart for determining a skew score associated with a demographic group, according to an embodiment of the present disclosure.

FIG. 3B illustrates an example scenario for determining a demographic distribution of subscribers of a service provider in a geographical region, according to an embodiment of the present disclosure.

FIG. 4 illustrates an example first method for determining a demographic distribution of subscribers of a service provider in a geographical region, according to an embodiment of the present disclosure.

FIG. 5 illustrates an example second method for determining a demographic distribution of subscribers of a service provider in a geographical region, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Determining Local-Level Demographic Distribution of Subscribers of Service Providers

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add connections, such as friends, or publish content items. Users of a social networking system can include subscribers of various types of service providers, such as telecommunication operators.

Service providers can provide services in various geographical regions. As just one example, there can be one or more telecommunication operators (“operators”) providing communication services in a geographical region (“region”). Each operator can have subscribers to the operator's communication services. Each operator can analyze data relating to the operator's subscribers. Conventional approaches specifically arising in the realm of computer technology can analyze data relating to subscribers of a specific operator in a region and provide information relating to the subscribers of the specific operator. However, conventional approaches may not have access to data relating to subscribers of all operators in the region. Accordingly, under conventional approaches, it can be difficult to provide information about subscribers of a specific operator in the region in comparison to subscribers of all operators in the region.

An improved approach rooted in computer technology can overcome the foregoing and other disadvantages associated with conventional approaches specifically arising in the realm of computer technology. Based on computer technology, the disclosed technology can provide metrics or statistics relating to subscribers of a service provider, such as an operator, in a region in comparison to subscribers of all service providers in the region. Subscribers of service providers in a region can include users of a social networking system. Accordingly, metrics can be provided based on aggregated and anonymized data relating to users of the social networking system. Aggregated and anonymized data relating to the users of the social networking system can include information about user device characteristics, general device location information (e.g., service provider location identifier), service providers associated with user devices, user demographic characteristics, etc. Such information can be obtained without identifying particular users.

The disclosed technology can determine metrics for subscribers of a service provider in a region. For example, metrics for subscribers of a service provider in a region can be determined relative to subscribers of all service providers in the region. Metrics can be determined based on one more attributes relating to subscribers. The disclosed technology can also determine variations for metrics that are associated with different demographic groups of subscribers of a service provider in a region. For example, a variation score can be determined to indicate a variation or skew of a demographic group of subscribers of a service provider in a region from (in comparison to) an average value of a metric for all subscribers of the service provider in the region. A demographic group can be determined based on any appropriate characteristic, such as a device characteristic, an age, an age range, a household size, etc. A distribution of values of a metric for a demographic group can be determined based on bootstrapping techniques. For example, if a selected metric is a market share, the disclosed technology can determine an average value of market share for subscribers of a service provider in a region, and determine a variation from the average value of market share for a particular demographic group of subscribers of the service provider in the region. The region can be selected at a local level. For example, the region can be determined at a sub-city level. By providing metrics and variations at a local level, the disclosed technology can provide granular analysis of demographic groups in a region for service providers, which can be helpful in allocating resources and efforts in connection with subscribers or potential subscribers in the region. In this way, the disclosed technology can provide information relating to demographic variations for a service provider at a local level, for example, in comparison to other service providers. Details relating to the disclosed technology are explained below.

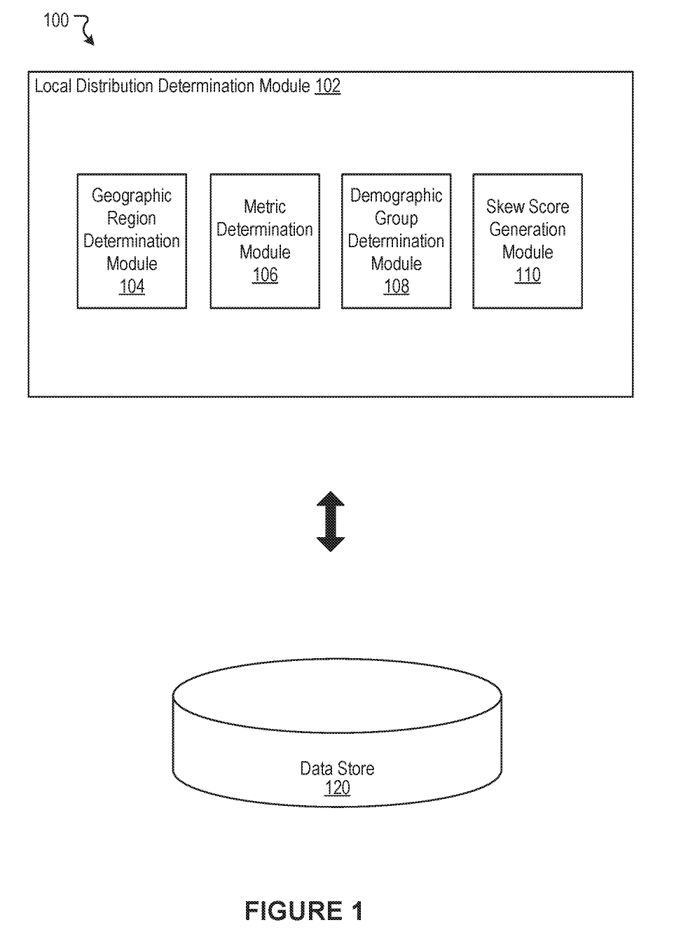

FIG. 1 illustrates an example system 100 including an example local distribution determination module 102 configured to determine a demographic distribution of subscribers of a service provider in a geographical region, according to an embodiment of the present disclosure. The local distribution determination module 102 can include a geographical region determination module 104, a metric determination module 106, a demographic group determination module 108, and a skew score generation module 110. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the local distribution determination module 102 can be implemented in any suitable combinations. While telecommunication operators are discussed herein as an example of a type of service provider, the present disclosure also applies to other types of service providers. In addition, while a social networking system is discussed herein as an example of a system, the present disclosure also applies to other types of systems.

The geographical region determination module 104 can determine a region for which to determine a demographic distribution of subscribers. In some embodiments, the region can be defined at a local level. For example, the region can be defined at a sub-city level, such as a census tract, a district within a city, an area defined by a zip code, a catchment area (e.g., a store catchment area), a marketing area of an operator, etc. In other embodiments, the region can be defined at a level higher than the local level. For example, the region can include a metropolitan area, a city and its suburbs, etc. In certain embodiments, the region can be defined to include at least a minimum number of subscribers. The minimum number of subscribers can be determined to provide or yield statistical significance. In some embodiments, the region can be specified by a service provider, such as an operator. All examples herein are provided for illustrative purposes, and there can be many variations and other possibilities.

The metric determination module 106 can determine a metric for which to determine a demographical distribution. The metric can be provided for a service provider, such as an operator, in a region. In some embodiments, the metric for a particular operator can be provided relative to all or other operators in the region. For example, the metric can be a market share, and the market share of an operator can be determined relative to overall market size that includes all operators in the region. In other embodiments, the metric for a particular operator can be provided without considering all or other operators in the region. The metric can also be determined for one or more demographic groups associated with an operator in a region. For example, an average value of the metric can be determined for all subscribers of an operator in a region, and a value of the metric can also be determined for one or more demographic groups of subscribers of the operator in the region. In some embodiments, the metric for different demographic groups of an operator can be provided relative to all or other operators in the region. In other embodiments, the metric for different demographic groups of an operator can be provided without considering all or other operators in the region. The metric for different demographic groups can be provided in a form of skew scores, for example, as explained below. In certain embodiments, the metric can be specified by an operator. Examples of metrics can include a market share, a share of gross adds, a share of churn, a household penetration, etc. All examples herein are provided for illustrative purposes, and there can be many variations and other possibilities.

The demographic group determination module 108 can determine one or more demographic groups for which to determine a metric. Demographic groups can be determined based on one or more attributes associated with subscribers. Users of the social networking system in a region can serve as a proxy for subscribers of service providers, such as operators, in the region. For example, it can be assumed that a user in a region is a subscriber of an operator in the region. In some embodiments, an adjustment can be made to correct any error or deviation between users of the social networking system in a region and subscribers of operators in the region. Data relating to users can be anonymized and/or aggregated in order to protect privacy of the users. For example, device-level information can be used without identifying user-level information. Location information can be determined based on a location identifier (ID) associated with devices. For instance, operators may use location IDs to identify service regions. In some embodiments, demographic groups can be specified by an operator. Examples of attributes can include an age, an age range, a gender, a household size, a device brand or manufacturer, a device model, a device tenure or ownership, network usage, etc. Since demographic groups can be determined based on various attributes, the demographic group determination module 108 can determine demographic groups at a granular level. All examples herein are provided for illustrative purposes, and there can be many variations and other possibilities.

The skew score generation module 110 can generate skew scores for one or more demographic groups of subscribers. A skew score or a variation score can indicate a variation of a demographic group from an average value of a metric. Skew scores can provide valuable information relating to performance of a service provider, such as an operator, with respect to particular demographic groups. The skew score generation module 110 is described in more detail herein.

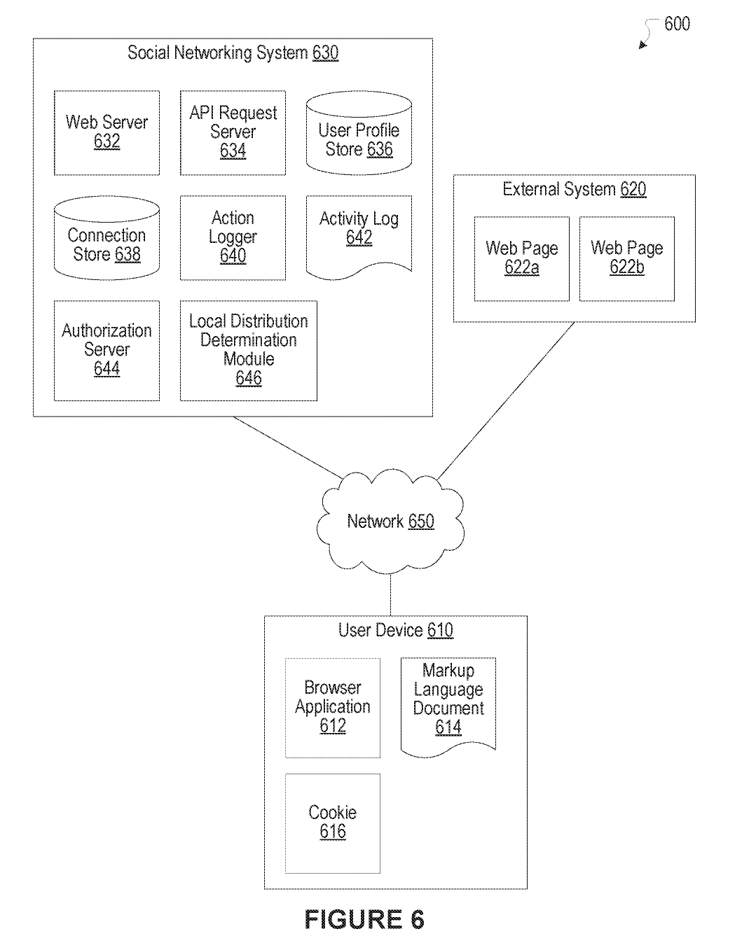

In some embodiments, the local distribution determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the local distribution determination module 102 can be, in part or in whole, implemented as software running on one or more computing devices or systems, such as on a server system or a client computing device. In some instances, the local distribution determination module 102 can be, in part or in whole, implemented within or configured to operate in conjunction or be integrated with a social networking system (or service), such as a social networking system 630 of FIG. 6. Likewise, in some instances, the local distribution determination module 102 can be, in part or in whole, implemented within or configured to operate in conjunction or be integrated with a client computing device, such as the user device 610 of FIG. 6. For example, the local distribution determination module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the local distribution determination module 102. The data maintained by the data store 120 can include, for example, information relating to service providers (e.g., operators), subscribers of service providers, users of a social networking system, attributes associated with users, demographic groups associated with users, regions, metrics, variation scores or skew scores, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the local distribution determination module 102 can be configured to communicate and/or operate with the data store 120. In some embodiments, the data store 120 can be a data store within a client computing device. In some embodiments, the data store 120 can be a data store of a server system in communication with the client computing device.

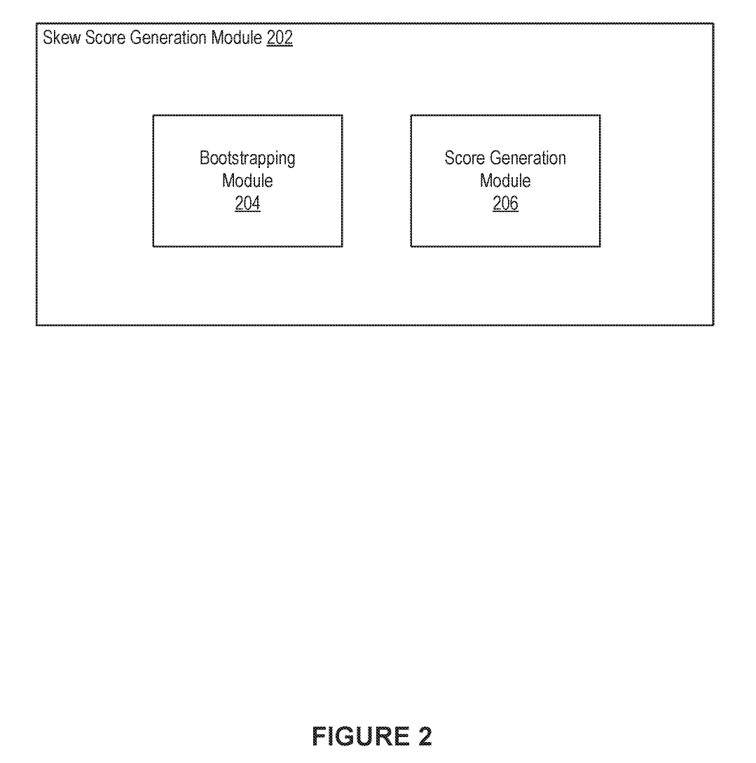

FIG. 2 illustrates an example skew score generation module 202 configured to generate skew scores associated with a demographic group in a geographical region, according to an embodiment of the present disclosure. In some embodiments, the skew score generation module 110 of FIG. 1 can be implemented with the example skew score generation module 202. As shown in the example of FIG. 2, the example skew score generation 202 can include a bootstrapping module 204 and a score generation module 206.

As explained above, a metric for a service provider, such as an operator, can be determined for a region. An average value of the metric for the operator can be determined for the operator's subscribers in the region. The operator's subscribers in the region can include one or more demographic groups, which can be determined based on one or more attributes associated with subscribers. One or more attributes associated with subscribers can include one or more attributes associated with the operator's subscribers in the region. A skew score can be determined for a demographic group, and the skew score can indicate a variation or skew of the demographic group from the average value of the metric. For instance, a metric to be determined for an operator in a region can be a market share in the region, and demographic groups for the operator can be determined based on attributes of age and gender. For example, demographic groups for the operator can include women ages 18-24 and women ages 25-34. An average market share can be determined for all subscribers of the operator in the region, and respective skew scores can be determined for the women ages 18-24 demographic group and the women ages 25-34 demographic group.

The bootstrapping module 204 can determine a distribution of values of the metric for a demographic group based on bootstrapping statistics. Repeated sampling with replacement from an empirical distribution of a relevant population associated with the metric can be performed. A relevant population can include subscribers of all service providers, such as operators, in a region that have attributes for a demographic group. For example, for the market share metric and the demographic group women ages 25-34, the relevant population can include subscribers of all operators in the region who are women ages 25-34 (“all women ages 25-34”). The empirical distribution of all women ages 25-34 can indicate a distribution of all women ages 25-34 in connection with operators to which they are subscribed. However, a normal distribution may not be assumed for a relevant population, for example, when the size of the relevant population is small. Accordingly, bootstrapping techniques can be used to estimate a distribution of values of the metric for a demographic group.

Distribution of values of the metric for the demographic group can be determined in relation to subscribers of all operators in the region having the attributes for the demographic group. Subscribers of all operators in the region that have the attributes for the demographic group can be referred to as a “bootstrapping sample population.” The bootstrapping sample population can be sampled with replacement and randomly in order to estimate the distribution of values of the metric for the demographic group. A value of the metric can be determined for each sample, and the distribution of values of the metric can be determined based on the value of the metric for each sample. For example, for the market share metric, the market share of the operator for the demographic group can be determined as a percentage of subscribers of all operators in the region in a selected sample. The value of the market share from each sample can be used to estimate a distribution of values of the market share. Bootstrapping can be repeated a specified number of times. For example, a number of times for performing bootstrapping can be specified by a parameter.

A p-value of the distribution of values of the metric can be used as the value of the metric for the demographic group. A p-value can indicate a probability that the value of the metric is higher than the value associated with the p-value. For example, p05 can indicate a p-value of 5, which can indicate a 95% probability that the value of the metric is higher than the value associated with p05. P50 can indicate a p-value of 50, which can indicate a 50% probability that the value of the metric is higher than the value associated with p50. P95 can indicate a p-value of 95, which can indicate a 5% probability that the value of the metric is higher than the value associated with p95. In some embodiments, p05 of the distribution from bootstrapping can be used as the value of the metric for the demographic group. If p50 is higher than the average value of the metric, p05 can be considered as a potential value of the metric for the demographic group. If both p05 and p50 are higher than the average value of the metric (e.g., both p05 and p50 are on the right side of the average value), it can be determined that p05 is statistically significant, and p05 can be used as the value of the metric for the demographic group. In other embodiments, p95 of the distribution from bootstrapping can be used as the value of the metric for the demographic group. If p50 is lower than the average value of the metric, p95 can be considered as a potential value of the metric for the demographic group. If both p50 and p95 are lower than the average value of the metric (e.g., both p50 and p95 on the left side of the average value), it can be determined that p95 is statistically significant, and p95 can be used as the value of the metric for the demographic group. If the estimated distribution of values of the metric from bootstrapping is determined to be statistically significant based on p-values, a skew score can be generated for the demographic group, for example, by the score generation module 206. If the estimated distribution of values of the metric from bootstrapping is determined not to be statistically significant based on p-values, a skew score may not be generated for the demographic group.

The score generation module 206 can generate a skew score or a variation score associated with a demographic group of a service provider, such as an operator, in a region. In some embodiments, a demographic group can be determined as follows:

cell=margin×geography (1)

where cell can indicate a demographic group of an operator, margin can indicate one or more attributes associated with subscribers of an operator, and geography can indicate a region for which a metric is determined. A margin can include one or more attributes. If the margin includes multiple attributes, a cross product of multiple attributes can be considered (e.g., a vector space of attributes). For example, the margin can include age and gender, and a cross product of age and gender can be considered. In some embodiments, the skew score for a cell can be determined as follows:

skew score=p05 of cell score/mean of subscribers (2)

where p05 of cell score can indicate p05 of a distribution of values of the metric for a cell based on bootstrapping, and mean of subscribers can indicate a mean or average value of the metric for subscribers of the operator in the region. If both p05 and p50 are on the right side of the average value of the metric for subscribers of the operator, p05 can be considered to be the value of the metric for the demographic group, and the skew for the demographic group can be positive. For example, for the market share metric, if the average market share for subscribers of the operator in the region is 50%, and p05 of market share for women ages 25-34 of the operator is 70%, the skew score for women ages 25-34 is 70%/50% =1.4. Women ages 25-34 of the operator are overrepresented by 40% (e.g., 1.4-1.0). The skew score can be provided relative to the average value of the metric. For example, the skew score of 1.4 can be provided as +4, which can indicate that the value of the metric is likely to be higher for the demographic group by 40%. In other embodiments, the skew score for a cell can be determined as follows:

skew score=p95 of cell score/mean of subscribers (3)

where p95 of cell score can indicate p95 of a distribution of values of the metric for a cell based on bootstrapping, and mean of subscribers can indicate a mean or average value of the metric for subscribers of the operator in the region. If both p50 and p95 are on the left side of the average value of the metric for subscribers of the operator, p95 can be considered to be the value of the metric for the demographic group, and the skew for the demographic group can be negative. For example, for the market share metric, if the average market share for subscribers of the operator in the region is 50%, and p95 of market share for women ages 25-34 of the operator is 60%, the skew score for women ages 25-34 is 60%/50%=1.2. Women ages 25-34 for the operator are underrepresented by 20% (e.g., 1.0-1.2). The skew score can be provided relative to the average value of the metric. For example, the skew score of 1.2 can be provided as −2, which can indicate that the value of the metric is likely to be lower for the demographic group by 20%. In some embodiments, for a cell that includes a large number of subscribers, a mean or average of values for subscribers in the cell can be used, instead of a skew score for the cell. As mentioned above, if bootstrapping results are not determined to be statistically significant for a demographic group, the score generation module 206 may not generate a skew score for the demographic group or generate a skew score of 0. All examples herein are provided for illustrative purposes, and there can be many variations and other possibilities.

By providing skew scores associated with an operator in a region, the disclosed technology can provide information on performance of the operator with respect to specific demographic groups, for example, in view of a metric. The operator can use the information to determine and/or optimize use or allocation of resources. For example, if the skew is high for a demographic group, the operator can analyze reasons for success and try to apply similar efforts to other demographic groups. Or if the skew is low for a demographic group, the operator can focus efforts on the demographic group. The information can be provided at a local level, which can be helpful for the operator in making local-level decisions and/or understanding local-level characteristics. For example, the information can be used to determine strategy optimization, determine operator store placement, determine local marketing actions, understand market position over time, etc. In this way, the disclosed technology can help the operator increase efficiency for various operations.

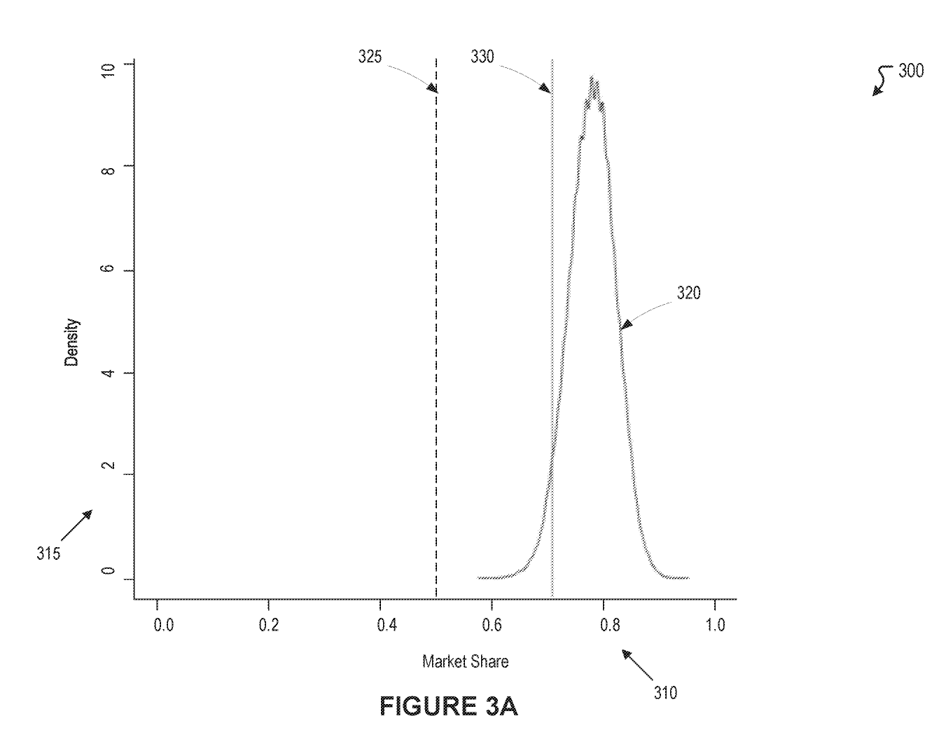

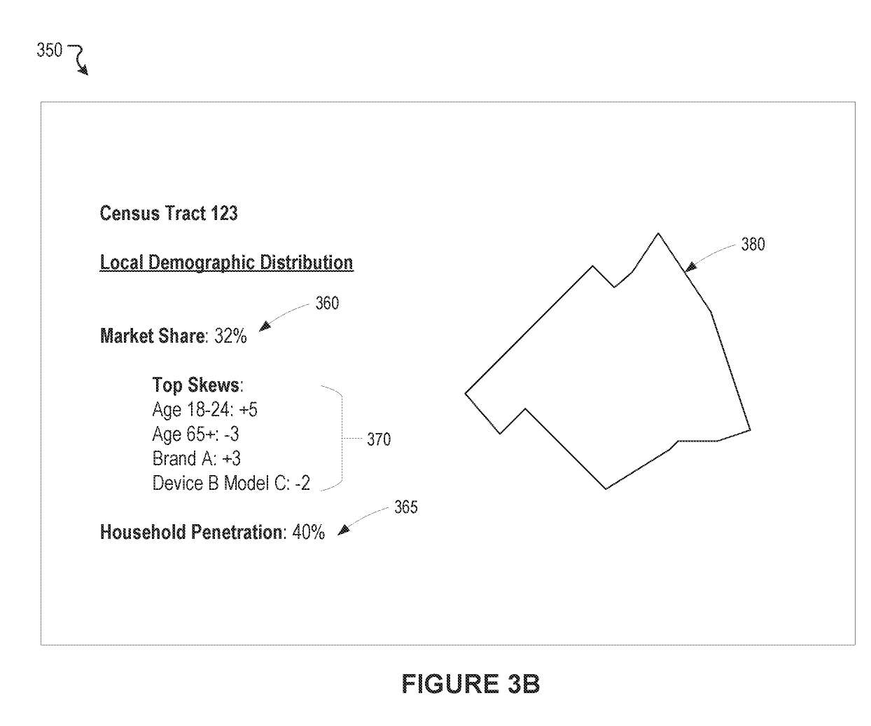

FIG. 3A illustrates an example chart 300 for determining a skew score associated with a demographic group, according to an embodiment of the present disclosure. The example chart 300 illustrates a distribution for a demographic group based on bootstrapping techniques. The demographic group can be associated with a particular service provider, such as an operator, in a region. An x-axis 310 of the chart 300 can indicate a metric of market share. A y-axis 315 of the chart 300 can indicate a density of values of the market share from bootstrapping. A line 320 can indicate a distribution of values of the market share for the demographic group based on bootstrapping. For example, the line 320 illustrates a density of values for market share that are determined from samples used in bootstrapping. The value of the market share for the demographic group from each sample can be plotted on the chart 300 to provide the distribution indicated by the line 320. Each sample can be selected randomly and with replacement. A line 325 can indicate an average value of market share for all subscribers of the operator in the region. A line 330 can indicate p05 of the distribution of values of the market share for the demographic group. As explained above, the value of the market share indicated by p05 can be used to determine the skew score when both p05 and p50 are higher than the average value of the metric.

FIG. 3B illustrates an example scenario 350 for determining a demographic distribution of subscribers of a service provider, such as an operator, in a geographical region, according to an embodiment of the present disclosure. The example scenario 350 illustrates an example of metrics and skew scores that can be provided to an operator. In the example scenario 350, the metrics and skew scores are provided for a census tract, Census Tract 123. The metrics include market share 360 and household penetration 365. Household penetration can indicate a percentage of subscribers associated with an operator within a household. The market share 360 of the operator in the census tract is 32%. Top skew scores 370 associated with the market share 360 are also provided. Demographic groups for which skew scores 370 are provided include Age 18-24, Age 65+, Brand A, and Device B Model 5. The respective skew scores 370 are +5, −3 +3, and −2. The household penetration 365 of the operator in the census tract is 40%. A shape or outline 380 of the census tract can also be provided.

An operator can specify a region, a metric, and/or a demographic group in which the operator is interested. If the operator does not specify the region, the metric, and/or the demographic group, default values can be provided. For example, if the operator does not specify the demographic group, skew scores can be determined for default demographic groups, and top skew scores can be provided.

Various operations can be performed based on the provided metrics and skew scores. In some embodiments, rule-based actions can be implemented based on the metrics and skew scores. For example, the operator can specify a trigger or an action to be taken when a value of a metric satisfies a threshold value. In certain embodiments, machine learning techniques can be used to optimize or improve performance of the operator based on the metrics and skew scores.

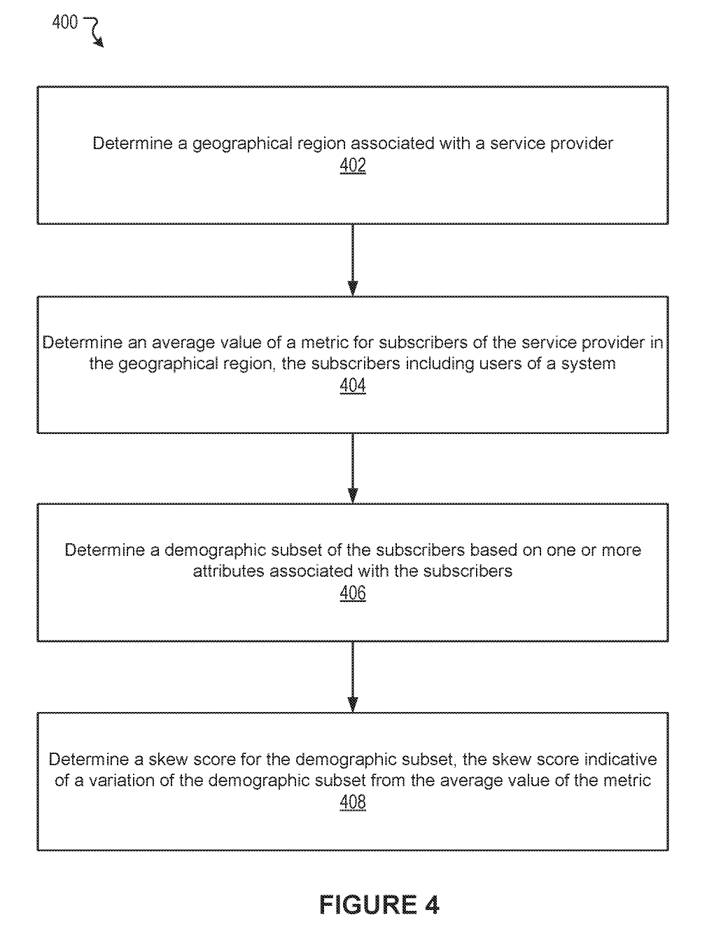

FIG. 4 illustrates an example first method 400 for determining a demographic distribution of subscribers of a service provider in a geographical region, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can determine a geographical region associated with a service provider. At block 404, the example method 400 can determine an average value of a metric for subscribers of the service provider in the geographical region, the subscribers including users of a system. At block 406, the example method 400 can determine a demographic subset of the subscribers based on one or more attributes associated with the subscribers. At block 408, the example method 400 can determine a skew score for the demographic subset, the skew score indicative of a variation of the demographic subset from the average value of the metric. Other suitable techniques that incorporate various features and embodiments of the present disclosure are possible.

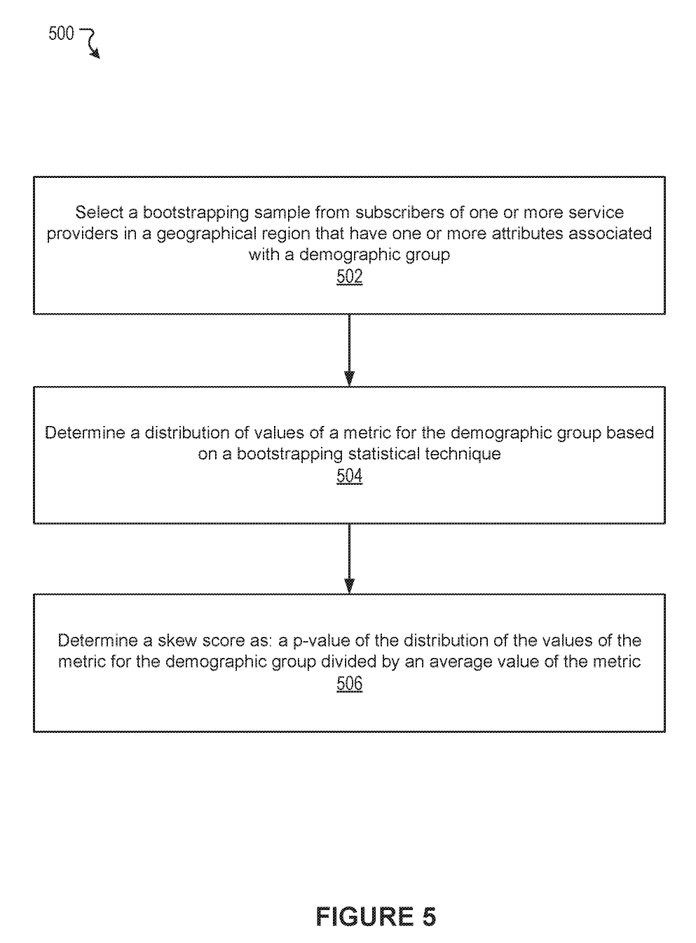

FIG. 5 illustrates an example second method 500 for determining a demographic distribution of subscribers of a service provider in a geographical region, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can select a bootstrapping sample from subscribers of one or more service providers in a geographical region that have one or more attributes associated with a demographic group. The demographic group can be similar to the demographic group explained in connection with FIG. 4. The geographical region can be similar to the geographical region explained in connection with FIG. 4. The one or more attributes can be similar to the one or more attributes explained in connection with FIG. 4. At block 504, the example method 500 can determine a distribution of values of a metric for the demographic group based on a bootstrapping statistical technique. The metric can be similar to the metric explained in connection with FIG. 4. At block 506, the example method 500 can determine a skew score as: a p-value of the distribution of the values of the metric for the demographic group divided by an average value of the metric. The average value of the metric can be similar to the average value of the metric explained in connection with FIG. 4. The skew score can be similar to the skew score explained in connection with FIG. 4. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an local distribution determination module 646. The local distribution determination module 646 can be implemented with the local distribution determination module 102, as discussed in more detail herein. In some embodiments, one or more functionalities of the local distribution determination module 646 can be implemented in the user device 610.

### Hardware Implementation

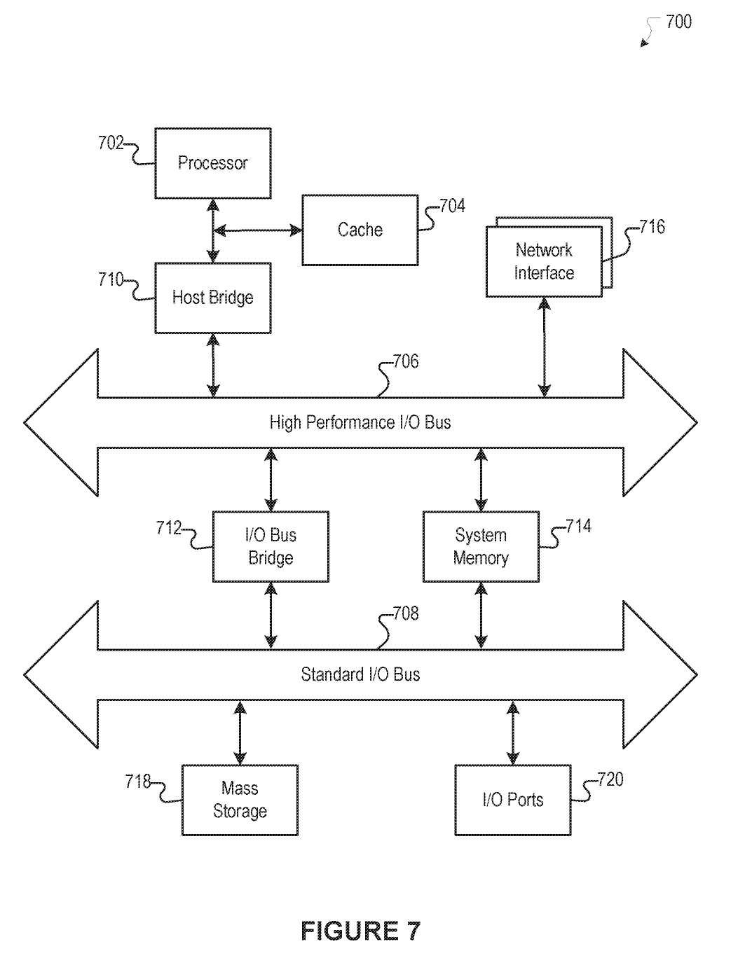

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a geographical region associated with a service provider;
determining, by the computing system, an average value of a metric for subscribers of the service provider in the geographical region, the subscribers including users of a system;
determining, by the computing system, a demographic subset of the subscribers based on one or more attributes associated with the subscribers; and
determining, by the computing system, a skew score for the demographic subset, the skew score indicative of a variation of the demographic subset from the average value of the metric.

2. The computer-implemented method of claim 1, wherein the geographical region is a portion of a city, the system is a social networking system, and the service provider is a telecommunication operator.

3. The computer-implemented method of claim 1, wherein the one or more attributes are selected from one or more attributes associated with the users of the system.

4. The computer-implemented method of claim 1, wherein the one or more attributes include one or more of: an age, an age range, a gender, a household size, a device brand, a device manufacturer, a device model, a device tenure, or network usage.

5. The computer-implemented method of claim 1, wherein the determining the skew score for the demographic subset is based on a bootstrapping statistical technique.

6. The computer-implemented method of claim 5, further comprising determining a distribution of values of the metric for the demographic group based on the bootstrapping statistical technique.

7. The computer-implemented method of claim 6, wherein a bootstrapping sample is selected from subscribers of one or more service providers in the geographical region that have the one or more attributes associated with the demographic group.

8. The computer-implemented method of claim 7, wherein the skew score is determined as: a p-value of the distribution of the values of the metric for the demographic group divided by the average value of the metric.

9. The computer-implemented method of claim 1, wherein the average value of the metric is determined relative to subscribers of one or more service providers in the geographical region.

10. The computer-implemented method of claim 1, wherein the metric includes one or more of: a market share, a share of gross adds, or a share of churn.

11. A system comprising:
at least one hardware processor; and
a memory storing instructions that, when executed by the at least one processor, cause the system to perform:
determining a geographical region associated with a service provider;
determining an average value of a metric for subscribers of the service provider in the geographical region, the subscribers including users of a system;
determining a demographic subset of the subscribers based on one or more attributes associated with the subscribers; and
determining a skew score for the demographic subset, the skew score indicative of a variation of the demographic subset from the average value of the metric.

12. The system of claim 11, wherein the determining the skew score for the demographic subset is based on a bootstrapping statistical technique.

13. The system of claim 12, wherein the instructions further cause the system to perform determining a distribution of values of the metric for the demographic group based on the bootstrapping statistical technique.

14. The system of claim 13, wherein a bootstrapping sample is selected from subscribers of one or more service providers in the geographical region that have the one or more attributes associated with the demographic group.

15. The system of claim 14, wherein the skew score is determined as: a p-value of the distribution of the values of the metric for the demographic group divided by the average value of the metric.

16. A non-transitory computer readable medium including instructions that, when executed by at least one hardware processor of a computing system, cause the computing system to perform a method comprising:
determining a geographical region associated with a service provider;
determining an average value of a metric for subscribers of the service provider in the geographical region, the subscribers including users of a system;
determining a demographic subset of the subscribers based on one or more attributes associated with the subscribers; and
determining a skew score for the demographic subset, the skew score indicative of a variation of the demographic subset from the average value of the metric.

17. The non-transitory computer readable medium of claim 16, wherein the determining the skew score for the demographic subset is based on a bootstrapping statistical technique.

18. The non-transitory computer readable medium of claim 17, wherein the method further comprises determining a distribution of values of the metric for the demographic group based on the bootstrapping statistical technique.

19. The non-transitory computer readable medium of claim 18, wherein a bootstrapping sample is selected from subscribers of one or more service providers in the geographical region that have the one or more attributes associated with the demographic group.

20. The non-transitory computer readable medium of claim 19, wherein the skew score is determined as: a p-value of the distribution of the values of the metric for the demographic group divided by the average value of the metric.
